(19) United States
(12) Patent Application Publication
(10) Pub. No.: US 2014/0228993 A1
(43) Pub. Date: Aug. 14, 2014

(54) APPARATUS, SYSTEM AND METHOD FOR CONTROL OF RESOURCE CONSUMPTION AND / OR PRODUCTION

(71) Applicants: Sony Europe Limited, Weybridge (GB); Sony Corporation, Minato-ku (JP)

(72) Inventors: Chris MINNOY, Holsbeek (BE); Bert Robben, Bierbeek (BE); Geert Premereur, Erpe-Mere (BE); Jan Spooren, Schoten (BE); Alfred Spiessens, Hingene (BE)

(73) Assignees: Sony Europe Limited, Weybridge (GB); Sony Corporation, Minato-ku (JP)

(21) Appl. No.: 14/061,303

(22) Filed: Oct. 23, 2013

(30) Foreign Application Priority Data
Feb. 14, 2013 (EP) 13155298.6

(51) Int. Cl. G05B 15/02

(52) U.S. Cl. CPC G05B 15/02
USPC 700/103

(57) ABSTRACT

A control apparatus comprises a user control for setting one or more parameters determining the resource consumption and/or production of future resource-consuming and/or producing events by a specific resource consuming and/or production device, the one or more parameters including a time period, longer than the length of each resource-consuming and/or producing event itself, during which the user allows that resource-consuming and/or producing event to take place, the future resource-consuming and/or producing events being associated with a user reward; and a display for displaying, to the user, (i) performance data indicating the predicted effect of setting the parameters on the performance of the resource consuming and/or producing device relative to one or more predetermined user requirements, so that the displayed performance data varies with variations in the one or more parameters set by the user control, and (ii) the user reward associated with at least currently selected parameters.

### FIELD

This disclosure relates to the control of resource consumption and/or production.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art.

The rising cost of energy due to scarcity and increased environmental consciousness forces consumers and business alike to employ the energy they use as efficiently as possible. One way this is achieved is by using the least expensive and/or the least polluting resource supplies available. Here, the term “resource supplies” refers to a consumable resource (such as electricity, gas, water or the like) as supplied to a domestic or business consumer by, for example, a utility provider.

In the case of resources such as gas and water, the instantaneous generation of the resource is not a problem, but it can still be considered cheaper, from the point of view of the utility company, to supply the resource in a balanced way, so as to avoid large peaks and dips in demand. This allows the utility company to make more efficient use of its storage and distribution network. Accordingly, some of the techniques to be discussed below can apply to supplied resources such as gas and water.

In the case of electricity as a supplied resource, many more factors need to be considered.

Looking first at the environmental cost of electricity generation, particularly by a utility provider, there is currently a general aim (which is often either required or incentivised by governments) to reduce the amount of pollutants resulting from electricity generation. This aim can be addressed, for example, by increasing electricity production in periods where less wind is available (to make up for reduced production by wind turbines) or where less sun is available (to make up for reduced production by photovoltaic installations). However, a characteristic of these renewable electricity sources is that their yields are hard to predict with great accuracy. Another characteristic is that traditional generation facilities, such as gas-fired plants, require time to become fully productive. Therefore, since it is not currently practicable for a utility provider to store and release large amounts of electricity directly, a way of improving the efficiency of usage of sun and wind power, when those sources are available, is to influence the consumption as much and fast as possible so that the consumption is aligned with the production. This type of arrangement is called a demand response (DR) arrangement.

Users can participate in a DR scheme by delegating some control over the usage (or local production) of their electricity-consuming and/or producing devices and appliances to a party that can adjust the timing and/or mode of usage of those devices and appliances. This party is called a demand-response aggregator in this description. In return for offering a certain level of control of devices they own to the demand-response aggregator, users may be rewarded either financially, by means of loyalty points or in other ways. Ideally, such a party should take into account the preferences of the user and the particularities of the devices and the environment in which it is used. Presumably, consumers are compensated for relinquishing full control and potentially lowering their comfort. The more that the aim of optimizing or improving the supply generation and distribution (the grid) is favoured over consumer comfort, the greater should be the compensation or reward for the consumer.

The control of local resource-consuming and/or producing devices involved in a DR system may for example be carried out by a hardware and/or software control apparatus within the user's premises, that (in the example of a domestic consumer) sends control signals to various devices such as washing machines, tumble dryers and electrical boilers.

An example of a DR reward in a domestic setting is as follows.

When electricity is abundant, or cheap, or environmentally generated, the water in a domestic hot water buffer (such as an electrical boiler and associated insulated hot water tank) can be heated for later usage (for example, several hours in advance). Conversely, when electricity is in high demand, the heating of cold water can be postponed given a large enough buffer. The more the water can be heated or left cold as dictated by grid needs, the more useful the domestic hot water buffer is from the point of view of the DR aggregator. At the same time, certain physical limits have to be obeyed: the water temperature should never exceed the operating limits nor should the water become so cold that the consumer cannot take a warm shower or bath.

Traditionally, domestic hot water buffers were controlled by turning a knob on an arbitrary scale from (for example) 1 to 5. Consumers, or installers, then had to adjust the settings until a satisfying comfort level was attained. This was a difficult process as there is little direct connection between the simple number and the desired outcome.

This difficulty in matching device settings to desired outcomes only gets worse when DR is included in the system. Without DR, it is in the consumers' best interest to keep heating levels as low as possible as long as comfort is not sacrificed. Indeed, the lower the temperature, the lower the heat losses and the lower electricity bill. With DR, however, a larger temperature range means more capacity for storing heat energy. If consumers are duly compensated, it makes sense for them to offer the maximum flexibility of the time of heating and the target temperature of their hot water buffer to a DR aggregator. If they do so, however the heating patterns of the buffer will potentially be quite different from the non-DR situation. As a result, correctly setting the hot water buffer parameters has become even harder for the user, which is especially a problem given that many modern hot water buffers that are suitable for D/R application have more or other parameters than just the temperature range.

Another local or domestic DR situation can relate to small-scale power generation, production or recovery (collectively termed as “production” here). Here, an example might be the use of a domestic or premises-based combined heat and power apparatus which generates relatively small amounts of electricity as a by-product of heat generation, or the use of storage batteries (which may have been previously charged under the control of a DR arrangement) to release power to the grid, or the use of premises-based fuel cells to generate power, or the recovery of stored power from an electric or hybrid vehicle while that vehicle is parked at the premises.

Of course, a single hot water buffer, considered alone, makes a trivial difference to the loading on an electricity supply company. Even when corporate consumers are considered, the difference in loading of the supply network by the DR activities of one user may still be minor. This is why, typically, a DR aggregator does not interact with only one appliance or one user, but instead combines or aggregates the DR activities of a group comprising many different users and resource consuming devices so as to produce a significant aggregate difference in the resource consumption of the group.

### SUMMARY

This disclosure provides a control apparatus comprising:

a user control for setting one or more parameters determining the resource consumption and/or production of future resource-consuming and/or producing events by a specific resource consuming and/or production device, the one or more parameters including a time period, longer than the length of each resource-consuming and/or producing event itself, during which the user allows that resource-consuming and/or producing event to take place, the future resource-consuming and/or producing events being associated with a user reward; and

a display for displaying, to the user, (i) performance data indicating the predicted effect of setting the parameters on the performance of the resource consuming and/or producing device relative to one or more predetermined user requirements, so that the displayed performance data varies with variations in the one or more parameters set by the user control, and (ii) the user reward associated with at least currently selected parameters.

This disclosure also provides a control system comprising:

control apparatus as defined above; and

a server connectable to the control apparatus, the server generating information defining one or more user rewards associated with implementing respective candidate future resource-consuming events.

This disclosure also provides a control method comprising:

setting one or more parameters determining the resource consumption and/or production of a future resource-consuming and/or producing event by a specific resource consuming and/or producing device, the one or more parameters including a time period, longer than the length of the resource-consuming and/or producing event itself, during which the user allows the resource-consuming and/or producing event to take place, the future resource-consuming and/or producing event being associated with a user reward; and

displaying, to the user, (i) performance data indicating the predicted effect of setting the parameters on the performance of the resource consuming and/or producing device relative to one or more predetermined user requirements, so that the displayed performance data varies with variations in the one or more parameters set by the user control and (ii) the user reward associated with at least currently selected parameters.

This disclosure also provides a non-transitory machine-readable storage medium on which is stored computer software which, when executed by a computer, causes the computer to implement the method as defined above, and such computer software itself.

Further respective aspects and features are defined in the appended claims.

It is to be understood that both the foregoing general description and the following detailed description are exemplary, but not restrictive.

### BRIEF DESCRIPTION OF THE DRAWINGS

A more complete appreciation of the disclosure and many of the attendant advantages thereof will be readily obtained as the same becomes better understood by reference to the following detailed description of embodiments, when considered in connection with the accompanying drawings, wherein:

FIG. 1 provides a schematic overview block diagram of a demand response (DR) system;

FIG. 2 schematically illustrates a DR system using multiple aggregators and multiple DR installations;

FIGS. 3a and 3b schematically illustrate a DR installation;

FIG. 4 schematically illustrates a hot water buffer system;

FIG. 5 schematically illustrates an air cooling and/or heating system;

FIG. 6 schematically illustrates a power controller and a controlled device;

FIG. 7 schematically illustrates a prosumption detector;

FIG. 8 schematically illustrates a user control and display unit;

FIG. 9 schematically illustrates a second embodiment of a user control and display unit;

FIGS. 10-12 schematically illustrate different embodiments of user displays and user controls;

FIGS. 13-15 schematically illustrate examples of user displays;

FIG. 16 schematically illustrates an aggregator; and

FIG. 17 schematically illustrates process steps associated with embodiments.

### DETAILED DESCRIPTION OF THE DRAWINGS

In overall summary, embodiments can provide controls to consumers that let the consumers manage the devices and appliances for which they are responsible by adjusting parameters that are directly related to their participation in DR and the device performance, which in turn can relate to their comfort.

Here, a DR action is an action taken by a user or at least in respect of production and/or consumption facilities which belong to or are otherwise under the control of that user, to achieve an alteration of production and/or consumption associated with a demand-response system. Examples of DR actions might include: lowering or increasing consumption by a device, allowing flexibility in the time of operation of a consuming device, lowering or increasing production by a device, allowing flexibility in the time of operation of a production device, or the like. So a DR action relates to varying (or permitting the variation of) a production and/or consumption “event”. Such an event may be a future resource-consuming and/or producing event by a specific resource consuming and/or producing device, the future event being associated with a user reward. Accordingly, the term “action” views the matter from the point of view of the user responsible for the controlled device, in that the user takes an action to set (or authorise the setting of) parameters under which the controlled device may operate. But it is the “event”, that is, an instance of resource consumption or production, set or authorised by the user, which actually justifies and gives rise to the DR rewards. But it can be seen that DR actions and DR events refer to the same occurrences, just from slightly different perspectives.

Using a hot water buffer (a storage tank with an associated heater, from which the user draws hot water for use) as an example, embodiments could have a user-adjustable slider bar with one part (for example, a right-hand part or portion) showing the estimated DR rewards during some time frame and another part (such as a left-hand part or portion) showing the minimum number of showers available to that user (that is to say, the lower limit of the number of showers that the user could take over the heating/non-heating cycle, based upon a preset or historic minimum shower water temperature and a preset or historic average shower water volume. Other embodiments could expand this and have (for example) a double slider: one for the night and one the day, or one for the week and one for the weekend. The reward could for example be monetary, or expressed in CO₂ reduction, or expressed in loyalty points. In embodiments the DR rewards and/or achievements could be directly communicated through one or more social networks.

Another example relates to a washing machine. The more beforehand a user is prepared to put clothes into the washing machine, or conversely the longer that the user is prepared to wait for a possible completion of the washing job, the more likely the washing machine is able to contribute to a DR goal. Embodiments can offer a virtual control such as a virtual (touch screen) turning knob that simultaneously shows the latest end time of the washing job and the amount of rewards (e.g. loyalty points) earned. It is then apparent to the user how his action contributes to DR and what the impact on his comfort or the performance of the controlled device is.

The controls may be (for example) shown on some display external to the controlled device such as a web page or a central dashboard.

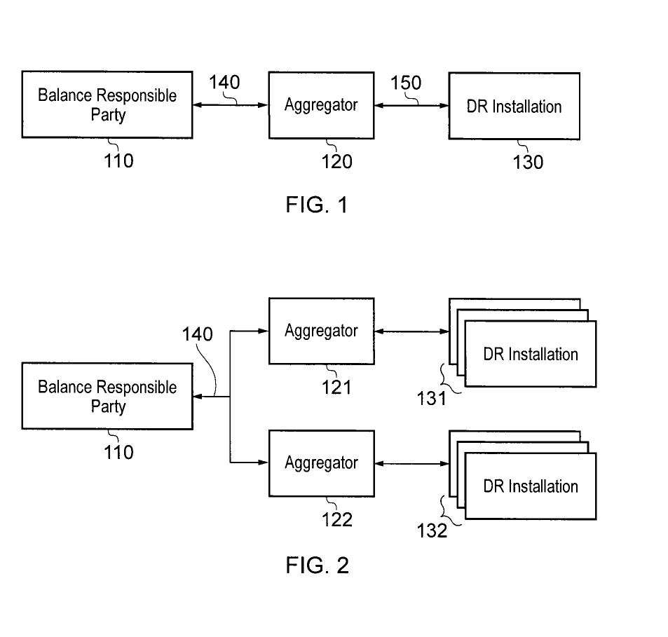

Turning now to the drawings, FIG. 1 provides a schematic overview block diagram of a demand response (DR) system comprising a balance responsible party (BRP) (a party which is responsible for ensuring, or at least attempting to ensure, that the supply of energy corresponds to the anticipated consumption of energy in its geographical area and/or consumer base of responsibility during a given time period) 110, an aggregator 120 and a DR installation 130. It will be appreciated that the present examples relates to electricity supply, but (as discussed above) similar principles and features can apply to the supply of other supplied resources such as gas or water. Note that the BRP may be associated with one or more supply providers, or may be independent of individual supply providers.

In some supply areas, such as in at least parts of Europe, there is a TSO (Transmission System Operator) that is responsible for grid stability and balance in a large geographic area (using high and mid voltage supply lines). A DSO (Distribution System Operator) is responsible for the low-voltage grid used by medium- and small sized enterprises and domestic consumers. Producers supply electricity to the high-voltage grid. They are not associated with consumers. Retailers buy from producers (directly and on an open market) and resell to enterprises and domestic consumers. Some of these parties have balance responsibilities, which they can pool, have managed by DR aggregators and so on. In Europe, the traditional electricity utility doesn't exist anymore.

Additionally, there is not only load balancing responsibility but also, for example, a voltage stability responsibility for the DSO. DR can be of aid here as well.

So, in the example of the resource being electricity, the BRP 110 needs to make sure that at all times substantially equal amounts of electricity are injected into the section of the grid which the BRP is responsible for, as are drawn from that section of the grid. Some aspects of the actual electricity consumption and production are unpredictable. Partly for this reason, the use of a DR system allows or helps a BRP to maintain a parity between demand and supply by varying the load requirements of DR-controlled devices.

Having said this, the work required to control individual domestic appliances is perhaps too detailed for a BRP to handle, so an intermediate stage of an aggregator (such as the aggregator 120) is provided. The aggregator may be embodied as a server which interacts with individual DR installations and combines the load-varying results of the DR activities of those installations into an aggregated DR outcome. Accordingly, the BRP 110 can indicate (for example, via a data connection 140) to the aggregator 120 that (for example) an increase in demand of x megawatts would be appropriate in y hours' time. The aggregator 120 interacts with multiple DR installations in order to achieve that change in load.

The individual DR installations 130 represent separate domestic, industrial or corporate users. For each such user, at least one local device is DR-controlled, as discussed below. The DR installations communicate with the aggregator 120 by means of a data connection 150.

FIG. 2 schematically illustrates a DR system using multiple aggregators and multiple DR installations. In most respects this arrangement corresponds to that shown in FIG. 1, and just serves to illustrate the fact that a BRP may interact with multiple aggregators 121, 122, each of which interacts with a respective group of multiple DR installations 131, 132. In this way, an aggregator is connectable to a group of DR installations and is operable to aggregate the resource consumption relating to DR events selected at the multiple DR installations in the group, so as to control a resource supply to the controlled devices associated with that group of DR installations.

Examples of systems relating to resource consumption, to resource production, and to resource consumption and production will be considered. In terms of both consumption and production, a storage device may draw power from the grid at an off-peak period (such as overnight) and release it to the grid at a peak time (such as during the working day). Note that in this context, “production” does not necessarily mean the initial production of the resource; retrieving a stored resource may also be considered as “production”. A DR reward could be provided to incentivise this consumption-production cycle. As a further example, an electric or hybrid vehicle may recover and store electricity (for example, by the generation taking place in a hybrid vehicle, or by braking regeneration in either an electric vehicle or a hybrid vehicle) and that stored electricity could be provided back to the grid as a power producing event (the “producing” being considered with respect to the grid, that is, at the time that the power is supplied to the grid, even though (in principle) the “production” could be considered to have taken place when the vehicle was being driven).

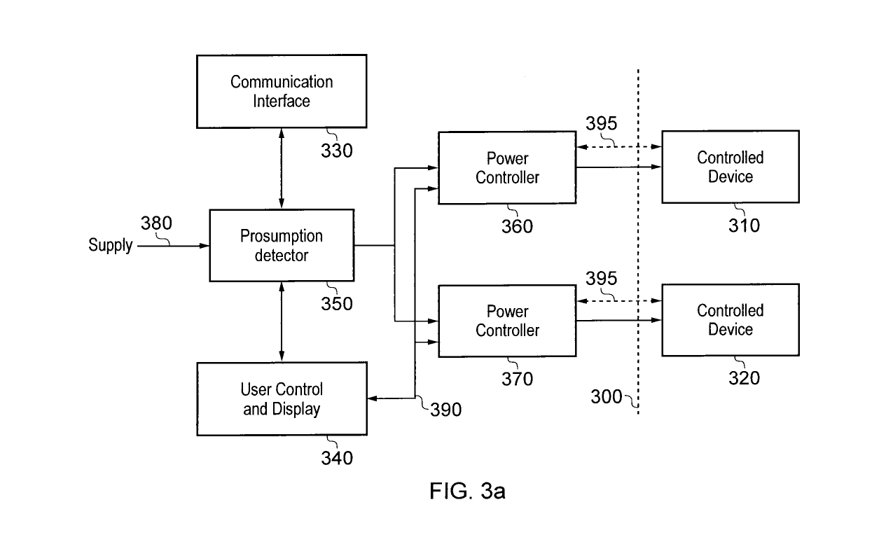

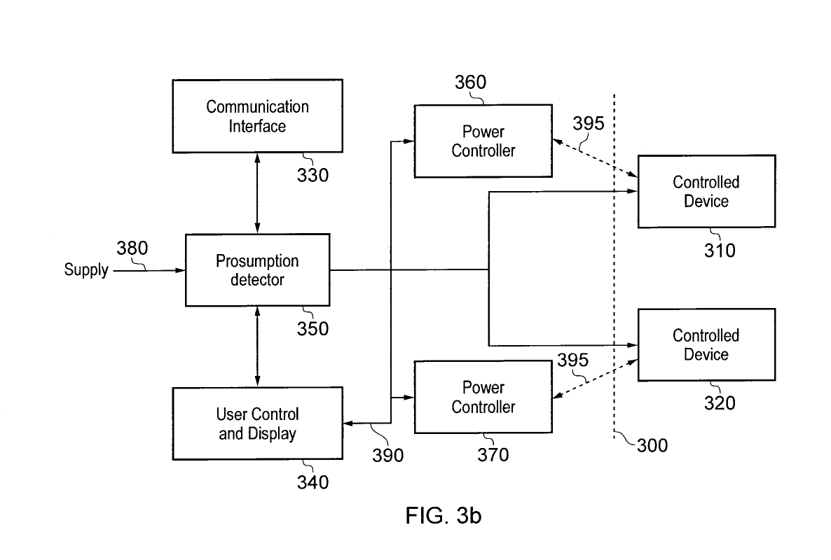

FIG. 3a schematically illustrates a DR installation 130.

The DR installation comprises two main components, shown either side of a dashed line 300, namely one or more controlled devices 310, 320 (only two such devices being shown for clarity of the diagram) and an arrangement to control the overall operation of the devices, and/or the power delivery to and/or from those devices and, optionally, the detailed operation of those devices.

In more detail, the DR installation 130 may comprise a communication interface 330 for data communication to or from the aggregator 120; a user control and display unit 340; a consumption/production (abbreviated to “prosumption” in the drawings) detector 350; and one or more power controllers 360, 370, there being (typically) one such power controller for each controlled device, connected to (or at least connectable to) the corresponding device so as to allow control of resource consumption (or production) by that device. Many of these components will be described in more detail below, but an overview of their operation will now be given.

Note that the user control and display 340 provides an example of a control apparatus comprising: a user control for setting one or more parameters determining the resource consumption and/or production of future resource-consuming and/or producing events by a specific resource consuming and/or production device, the one or more parameters including a time period, longer than the length of each resource-consuming and/or producing event itself, during which the user allows that resource-consuming and/or producing event to take place, the future resource-consuming and/or producing events being associated with a user reward; and a display for displaying, to the user, (i) performance data indicating the predicted effect of setting the parameters on the performance of the resource consuming and/or producing device relative to one or more predetermined user requirements, so that the displayed performance data varies with variations in the one or more parameters set by the user control, and (ii) the user reward associated with at least currently selected parameters. These functions of the user control and display 340 will be described in more detail below.

The communication interface 330 provides data communication to and from the aggregator 120, for example via an Internet data connection, although in other embodiments a data connection in which data signals are modulated onto a power supply line may be used. The communication interface 330 may in some embodiments receive data from the aggregator 120 defining user rewards applicable to DR actions which could be taken at the DR installation, and transmits data to the aggregator 120 (or to another third party) defining those DR actions which have been taken and, optionally a verification of those actions by the prosumption detector 350.

Note that other communication arrangements are possible. For example, the DR rewards could be estimated locally and displayed to the user as estimates, with confirmation later being obtained from the aggregator 120. The communication interface could also act to negotiate rewards, by indicating offers of possible DR actions to the aggregator along with requests for rewards, and receiving the aggregator's approval or disapproval of the offer.

The user control and display unit 340 has various functions. At a basic level, this unit provides a graphical display to the user of potential DR actions and the resulting effect of those actions, at least in terms of the user rewards which would be accrued by undertaking such an action. In order to do this, the user control and display unit comprises a display such as a liquid crystal display (LCD) panel and one or more user controls which may be implemented as touch screen controls or discrete physical buttons or other controls. At a more advanced level, the unit 340 may derive candidate DR actions for the user to select based upon data received from the aggregator 120 and/or other input data.

The prosumption detector 350 monitors the power consumption of (and/or power generation by) the controlled devices 310, 320. In the case of consumption, this is achieved by detecting changes on a power supply line 380 (which is in the depicted embodiment passed, via the prosumption detector 350, to the power controllers 360, 370 and from there to the controlled devices 310, 320). In the case of production, the detection may also be by detecting the effect on the supply line of power generation by the controlled device. Again, detailed techniques will be discussed below, but an overall aim of the prosumption detector is to verify implementation of a resource-consuming or resource-generating or producing event (for example, relating to a DR action established by the user operating the user control and display unit 340) by detecting time or frequency dependent patterns of resource consumption or production indicative of the resource consumption of or production by the specific controlled device under consideration. It is possible for a separate prosumption detector 350, or at least separate instances of the power prosumption sensing portion (see below) of such a detector, to be associated with each controlled device, for example at the power controller 360, 370 corresponding to a respective controlled device. Depending on the detection techniques used by the prosumption detector 350, this can in principle give a more accurate detection and verification operation. For simplicity of the diagram, however, and to illustrate an embodiment having just one such detector, a single prosumption detector 350 is illustrated in FIG. 3a.

Each power controller 360, 370 receives the electricity supply 380 and also a control signal 390 from the user control and display 340. The power controllers acts to switch the supply power in response to the control signal 390. In some embodiments, this is all that the power controllers do, in that the controlled devices either receive power or they do not receive power for respective time periods. In other embodiments, optionally the power controllers 360 can also (or instead) act to control the detailed operation of the controls devices, for example via data connections 395. Examples here might include setting a thermostat operating temperature or temperature range of a fluid heating or cooling device (such as a water heater or an air heater or cooler, where the temperature which is set refers to an output temperature of the fluid as an operational parameter) or selecting a type of washing cycle in a dishwasher or clothes washing machine. Again, these operations are carried out under the control of the control signal 390 received from the user control and display unit 340.

Note that the power controllers can operate to switch on or off the electricity delivery to and/or from the controlled device, or can operate to tell the device itself (by a control interface using the data connections 395) to switch on or off or to vary its operation. The device is controlled in accordance with parameters of the event specified by user input or communication with a third party such as a DR aggregator.

In the case of resource production by the controlled devices, the power controllers may act to initiate and control the generation of electrical power by the controlled devices, or in a simpler arrangement may act just to pass (or not to pass) power generated by the controlled devices to the grid.

FIG. 3b schematically illustrates a very similar arrangement, but in this case the power controllers only interact with the respective controlled devices via the data connections 395, which is to say that the power controllers do not directly switch the power to or from the controlled devices, but only instruct the controlled devices to do this themselves.

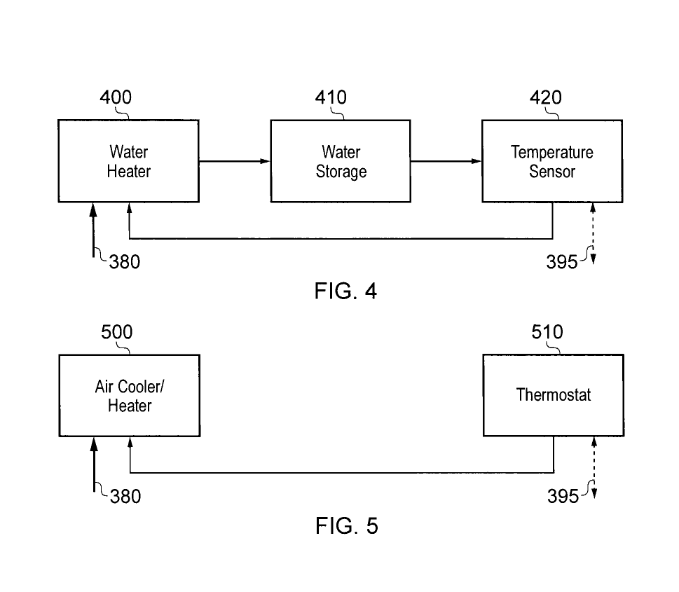

As examples of controlled devices 310, 320, FIG. 4 schematically illustrates a hot water buffer system and FIG. 5 schematically illustrates an air cooling and/or heating system. In FIG. 4, a water heater 400 heats the water in a water storage tank or buffer 410. The temperature of the heated water is detected by a temperature sensor 420 which also operates to provide a thermostatic control of the water heater 400. The temperature at which the thermostatic control operates may be set by the respective power controller using the data connection 395. The water heater 400 receives an electricity supply 380 via the power controller. In FIG. 5, the arrangement is similar but without the buffer or tank. A heater or cooler arrangement 500 heats or cools the ambient air, with the temperature of the resulting air being detected by a temperature sensor and thermostat 510. As before, the thermostat may interact with the respective power controller using the data connection 395 to set a required air temperature, and the air cooler/heater 500 receives a power supply 380 from the respective power controller.

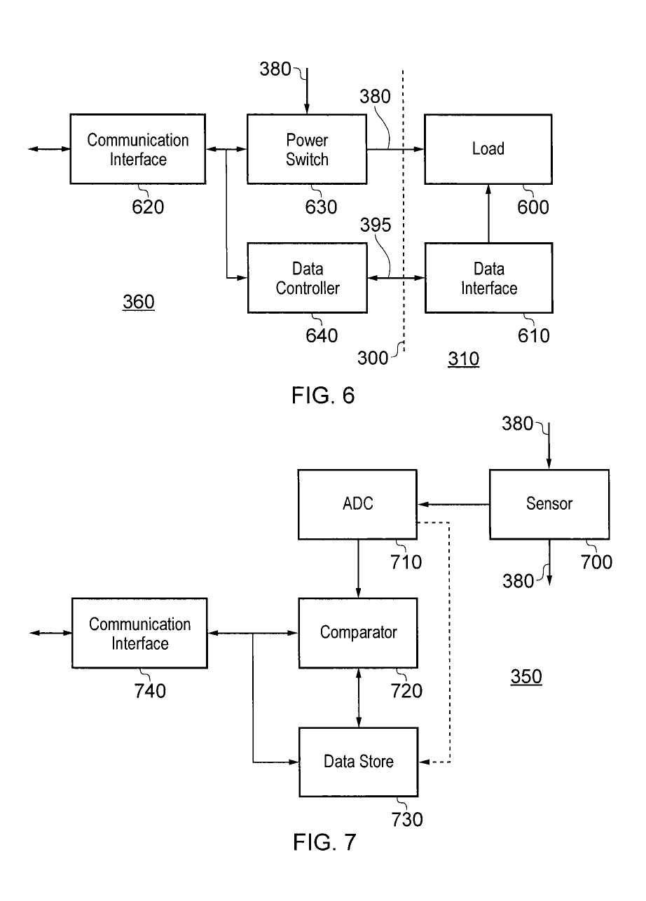

FIG. 6 schematically illustrates a power controller 360 and a controlled device (for example, the device 310).

Looking first at the controlled device 310 in the context of resource consumption, the device comprises a load 600 which acts as a load to the power supply 380. Examples of such a load include a motor, a heater, an amplifier and the like. Note that individual loads 600 may have different properties when connected to the power supply 380. For example, their impedance may be different. It is at least partly through differences in the properties of the individual loads 600 that the prosumption detector 350 can detect the presence and use of one load against another load. Optionally, the controlled device 310 includes a data interface 610 for communicating via the data link 395 to receive control signals to control the operation of the device 310. For example, the data interface 610 may receive a control signal defining a required temperature or temperature range of a thermostat (not shown in FIG. 6) which controls the load 600 acting as a heater or cooling device.

The power controller (such as the power controller 360 comprises a communication interface 620 for receiving data from and (if appropriate) sending data to the user control and display unit 340 via the data interface 390. The power controller 360 may receive data from the user control and display unit 340 which defines power switching operations and data communication operations with respect to the control of the controlled device 310. Data which defines power switching operations is routed to a power switch 630 and data defining communications operations and control signals is routed to a data controller 640. The data controller 640 supervises the transmission of control signals to the data interface 610. The power switch 630 acts to switch on or off (or, in some embodiments, to modulate) the supply power 380 which is passed to the load 600.

In some circumstances there could be a return data path from the data interface 610 to the data controller, from there to the communication interface 620 and from there to the user control and display unit 340. The type of data which may be passed along this return path could include, for example, performance data indicating the actual performance of the controlled device 310. For example, if the controlled device 310 is a water heater, control data sent in a forward direction (towards the data interface 610) may specify a required water temperature. However, the question of whether that water temperature is actually achieved, and if so, over what timescale relative to the heating cycle, is a different matter. Simply setting a required temperature as a thermostat does not guarantee that the required temperature will be reached by the thermostatically controlled heater. So, the return data path can indicate actual performance of the controlled device 310 which, in some embodiments, can be stored as historical performance data (see below).

Considering the same arrangement but in terms of resource production by the controlled device, the “load” may act under some circumstances as a power source, such that power is passed from the load 600 to the power switch 630 and from there to the grid.

FIG. 7 schematically illustrates a prosumption detector.

As discussed above, the prosumption detector aims to verify that DR actions have been carried out, by comparing the actual power consumption and/or production at certain times with the power consumption and/or production which should correspond to the agreed DR action.

The prosumption detector 350 comprises a sensor 700 associated with the power supply 380. The sensor may be an in-circuit sensor such as a predetermined load across which a test voltage can be measured. However, in other embodiments, the sensor 700 is an inductive, non-contact sensor. Such sensors can detect current flow in an alternating current system by inductively coupling to a conductor carrying the current to be measured. In practice, such sensors may comprise a graphite loop surrounding a supply cable, in which loop currents are induced in response to the current being passed by the supply cable. As discussed above, individual sensors 700 may be provided in respect of each controlled device 310, 320, or a single sensor may be provided on the overall supply.

The analogue output of the sensor 700 is converted to a digital form by an analogue-to-digital converter (ADC) 710. In some embodiments, the digitised sensed signal is then compared by a comparator 720 with so-called signature or profile data stored in a data store 730. The signature or profile data indicates time or frequency dependent properties of individual controlled devices in either a consumption or a production mode. These data may be established by empirically sampling the real performance of the particular devices employed by the user and storing the sampled results (or an average of several sampled results such as 10 sampled results in normal use) in the data store 730. Alternatively, the signature or profile data can be pre-loaded into the data store 730 at manufacture, and then particular signatures may be selected when the controlled devices are installed at the user premises. Additionally or alternatively, the signature of profile data can be acquired after installation by means of the communication interface 620 accessing an external network such as the internet.

The comparator 720 receives data from the user control and display unit 340 or from the aggregator 120 defining a particular DR action and associated time period. An example of such data may specify “operate washing machine for a 60°, fast spin cycle starting at 16:00 and ending at 16:30 on Tuesday 5 January”. It is a role of the prosumption detector to detect whether this task has been fully executed. To achieve this, the comparator 720 compares the digitised output of the ADC 710 with the stored signature data to generate at least a first result indicative of whether the controlled device was indeed operational at the expected power level during the time specified by the agreed DR action (subject to a predetermined tolerance in measurement time such as +/−5 minutes). This first result is sent to a communication interface 740 which transmits the result to the interface 330 and from there to the aggregator 120.

So, referring to the particular example given above, the comparator 720 accesses signature or profile data in the data store 730 relating to the expected time and/or frequency dependent properties of the load 600 within the washing machine (acting as the controlled device) for a 60°, fast spin cycle. The signature or profile data may specify a succession of time periods and associated power consumptions during this time periods (for example, first 5 min at 100 W, next 10 min at 2 kW, and so on), and it may also (or instead) specify other properties of the load's interaction with the supply. For example, a washing machine motor is primarily an inductive load whereas a washing machine heater is primarily a resistive load. The switching mechanism which controls the operation of the washing cycle within the machine may introduce high-frequency noise into the power supply. Each of these signal features, and times (relative to the cycle start time) at which the features are apparent in the power supply measurements, are specified by the signature or profile data corresponding to that controlled device and, in embodiments, the particular cycle or set of operations being undertaken by that controlled device. Each such measurement specified in the signature or profile data may have an associated tolerance (in time, power consumption, power production, resistance, impedance, frequency response, electrical noise level or the like) to allow for reasonable variations, such as variations in the inlet water temperature (resulting in different heating requirements within the washing machine). Alternatively, or an addition, a default tolerance of (say) 10% on any specified measurement or time period may be allowed. It is also noted that variations in, for example, the water inlet temperature (which may occur seasonally or from geographical place to place) can affect the power consumption profile. Also secondary features generated from the aggregate of all measurements may be used, such as the ratio between the highest and lowest value, the number of peaks, percentage of time above average. Furthermore, synthetic features as determined by machine learning techniques and which don't have an intuitive meaning may be allowed. As an illustrative example of this, a machine learning algorithm might use 0.2345 of the sample's power at time t+1 s add that to 0.4567 of the sample's air pressure at t+2.345 s and divide it by the water temperature yesterday. It would do that if it determines there is a positive correlation between such a synthetic feature and the desired outcome. In other examples many (possibly thousands of) seemingly irrelevant numbers would be combined into a single number that is a good indicator for what the system wants to achieve. That number itself has no intuitive meaning. One technique is called “dimension reduction” that reduces millions of sample values to a vector of 100's of values. Then that vector is multiplied by matrices of 10's of 1000's of numbers that themselves are obtained by some minimisation algorithm based on previous measurements.

As mentioned above, the first result is generated by the comparator 720 indicates whether or not the expected consumption and/or production cycle took place at the expected time. This result is transmitted back to the aggregator 120. At a basic level, if the first result indicates that the expected cycle took place at the expected time (according to the agreed DR action) then the reward corresponding to that action may be credited by the aggregator 120 to the user. If the first result is negative, which is to say that it indicates that the expected cycle did not take place at the expected time (perhaps the cycle took place but at the wrong time, or the cycle did not take place at all, or the wrong cycle took place at the right time) then at a basic level, the aggregator 120 may refuse to credit the reward to the user.

It is possible for the comparator 720 to generate a second result indicative of whether the controlled device is operating substantially correctly. Again, this is based upon the comparison made between the expected power consumption (or other time or frequency dependent signal properties) and the measured results. In the case of a single measured result which disagrees with the expected profile, the system may have determine that this simply represents a detection that the required cycle did not take place at the required time in order to qualify for the user reward for the particular DR action. However, if repeated negative first results are obtained, and in particular if repeated negative first results are obtained for one particular controlled device or one particular operation or cycle by that controlled device, the comparator 720 may generate the second result indicating a potential fault with the controlled device. Accordingly, in order to do this as a detection over multiple instances, the comparator 720 may store, for example in the data store 730, an indicator that the last n first results associated with a particular controlled device or a particular signature or profile have been negative. When the stored value n exceeds a threshold amount (such as 5) the second result indicating a potential fault may be generated. As an alternative way of generating the second result indicating a potential fault, if the comparator 720 detects that some but not all peaks in the expected power consumption correlate well with actual peaks in the measured power consumption, this could indicate that one component of the controlled device (for example, a motor or a heater) is working properly but another component is not. Here, there is less need to correlate the results over multiple instances, though this still could be done in order to confirm the detection of a fault and avoid generating false positive detections.

In order to distinguish between a genuine device malfunction and a simple non-compliance with DR requests, the comparator 720 may compare measurement features from times when a DR action was requested and times where the device was operating under direct control of the user. These situations may be distinguished by the DR installation which has a record of when it instructed a DR action and when it did not. For comparable goals, if both measurement features match one other but do not match the expected profile, device malfunction (with respect to parameters associated with the current DR event) is more likely. If on the other hand profile-matching measurements are achieved significantly more often during direct-controlled operation than during DR-controlled operation, then fraud is quite likely.

Note that the expected profile or pattern can be device dependent, that is, dependent upon a specific device or a type of device (such as a manufacture's part number). the control apparatus may access a database (held internally or externally) to obtain an expected pattern or profile appropriate to a device under control.

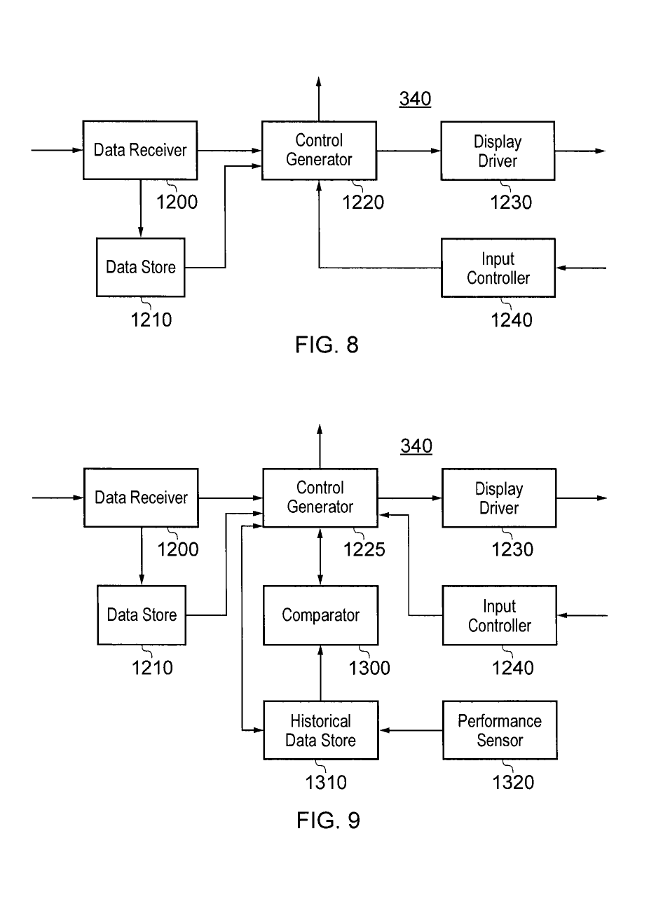

FIG. 8 schematically illustrates one implementation of the user control and display unit 340. The unit comprises a data receiver 1200, a data store 1210, a control generator 1220, an optional display driver 1230 and an input controller 1240.

The data receiver 1200 is arranged to receive data from the aggregator 120 via the communication interface 330 and (optionally) to store that data in the data store 1210. The received data defines parameters or other data associated with potential DR actions and associated user rewards. The actions and associated rewards can be defined individually (for example: “reduce water heater thermostat to 50° for the next week to generate a reward of x Euros” or “generate 2 kWh between 16:00 and 17:00 each day for the next week to earn a reward—in addition to the power feed-in tariff—of y Euros”). Alternatively, or in addition, actions and associated rewards can be defined parametrically. Here, an example might be as follows:

Deferral of washing machine cycle:

each additional hour on required end time: 10 points

each 10° reduction in wash temperature from an initial temperature of 60°: 15 points

So, a hypothetical user who agrees (via a user interface to be described) to a DR action comprising setting a required end time for a two-hour wash cycle at 10 hours beyond the current time (eight additional hours being specified) and setting the wash temperature as 30° would qualify for 125 “points” as a user reward (subject, in embodiments, to verification by the prosumption detector 350 that the agreed action does in fact take place).

As mentioned, the data defining potential DR actions are stored in the data store 1210. The control generator 1220 retrieves the stored data from the data store 1210 and, from it, generates either or both of: a discrete set of candidate DR actions for selection by the user, each being associated with a corresponding user reward; and a continuously or stepwise adjustable DR action, with the user reward being updated at each user adjustment.

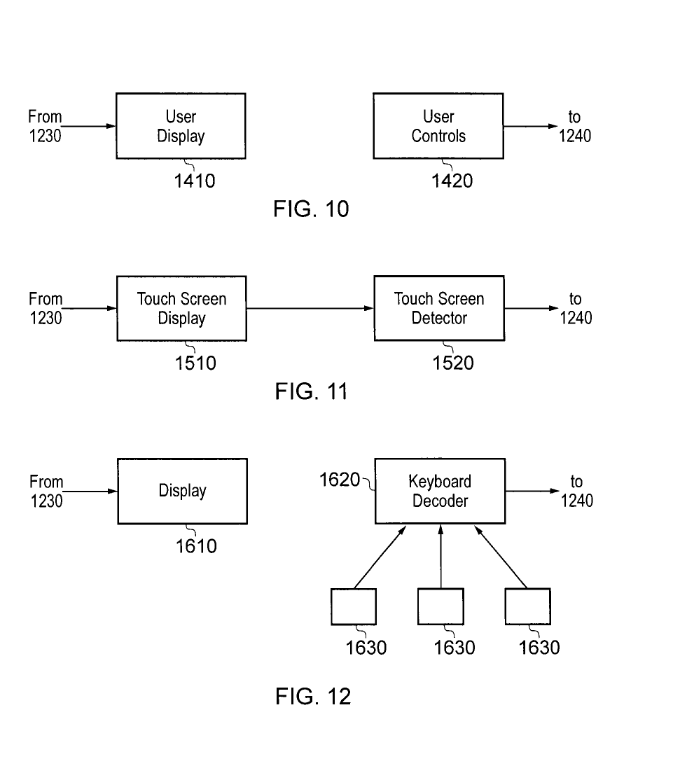

As examples of the discrete set of candidate DR actions or events for display to the user, each candidate event being displayed with an associated user reward, it may be that the data received from the aggregator 120 already defines these as individually selectable actions. If not, for example if the data received from the aggregator 120 is in parametric form as discussed above, then the control generator 1220 is operable to select a predetermined number of permutations of the parameters to form candidate DR actions for display to the user via the display driver 1230 and the display of any of FIGS. 10-12. The predetermined number may correspond to a number (for example, 10) of options which can conveniently be displayed by the user control and display unit 340, either as a single list or as a scrollable list. It is desirable not to present the user with too many options or the user's choice becomes too difficult. In order to generate the permutations, a predetermined algorithm may be used, for example involving varying each of the parameters supplied by the aggregator 120 across its full range and selecting sample values of each parameter which are evenly spaced across that range. The corresponding rewards can be derived using the parametric data provided by the aggregator 120. So, in embodiments, at least some of the candidate resource consuming and/or producing events may differ from one another by a time or time period at which the resource consuming and/or producing event is allowed to take place. In other embodiments, at least some of the candidate resource consuming and/or producing events may differ from one another by an average or peak operational parameter of the resource consuming/producing device over a period of time (an example being a thermostat temperature setting in relation to a water heater).

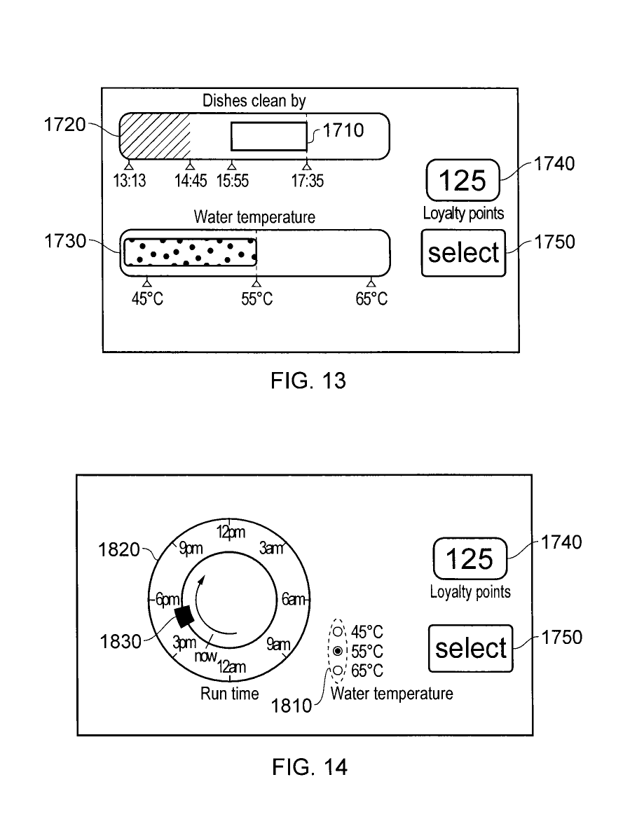

As a continuously or stepwise adjustable DR action, user controls may be provided (similar to those to be described with reference to FIGS. 13-15 below) which allow the user to adjust individual parameters such as wash temperature, number of showers required, wash deferral period and so on, with the control generator 1220 then generating and displaying the corresponding user reward from the parameter data stored in the data store 1210.

The display driver 1230 acts simply to generate data for display in dependence upon the output of the control generator 1220, and the input controller 1240 handles control inputs corresponding to user operation of user controls and passes these to the control generator 1220.

When the user has selected a DR action, details of this are passed by the control generator 1220 to the prosumption detector 350 and, optionally, to the aggregator 120.

FIG. 9 schematically illustrates a second embodiment of a user control and display unit. Several features of FIG. 9 are identical to those shown in FIG. 8 and will not be described again. The operation of the control generator (numbered as 1225 in FIG. 9) is a little different in some respects to that described with reference to FIG. 8. Some additional components are provided in FIG. 9, these being a comparator 1300, a historical data store 1310 and a performance sensor 1320.

The historical data store 1310 is used to store data indicating the “performance” of the controlled device in response to variations in the power supply to the device (or the production of power by the device) corresponding to DR actions. To do this, the results of a performance sensor 1320 are digitised and stored in the historical data store 1310, along with details of the DR action which was the basis of that performance of the device.

To make this clearer, some concrete examples will be given.

### Example 1

The user selects, as a DR action generating significant rewards, a restriction on hot water heating to just one hour per day, though at a thermostat temperature of 80° Celsius. Here, the performance sensor detects the actual (rather than the target) temperature of the water over the remaining 23 hours of the day and stores the results in the historical data store in association with details of the DR action which led to that performance.

### Example 2

The user runs an air cooling unit throughout the summer, varying the power allowance and thermostat parameters by which the air cooling unit may operate. The performance sensor detects the actual (rather than target) air temperature within the building as well as the ambient air temperature outside the building, and stores this data in the historical data store alongside details of the power and thermostat parameters in use on each day.

### Example 3

The user likes to take showers. The historical data store is populated with data (from a suitable water flow and water temperature sensor) indicating how many showers the user likes to take and at what temperature the user prefers to enjoy the shower. Note that this particular type of data can be populated manually into the historical data store (rather than acquiring it via sensors). Alternatively information provided by device manufacturer or data collections can be used (e. g. indicating that a boiler of type xyz provides for z hot showers of average water consumption if heated to temperature y). Such kinds of data could be enhanced by sensor data or manual input, since such provided data does not consider location-specific conditions (e. g. very cold basic water temperature) or specific user behaviour (for example, the user likes to take very long showers). It will be seen that the data stored in the historical data store allows the control generator 1225 to make a sensible prediction of the outcome, in terms of device performance, for a particular DR action being selected by the user. Reference is made to European patent application number 12151073.9.

So, in the case of Examples 1 and 3, if the user sets the water heating to be restricted to one hour per day, then even if the user sets a high thermostat temperature, the control generator 1225 may detect from the historical data stored in the historical data store 1310 that the results will be disappointing from the user's point of view. In particular, the control generator 1225 may detect from the historical data that only (say) 50 litres of hot water at the user's required sharing temperature (say, 40°) or above will be generated, and given that the parameter defining the user's typical shower (45 litres of water) is also stored in the historical data store, the control generator 1225 can establish that this particular DR action will generate enough hot water for only one shower in a 24-hour period.

In the case of Example 2, from a measurement of the actual ambient (outside) temperature and the power and thermostat parameters selected by the user for a particular DR action in respect of the air cooling unit, the control generator 1225 can predict the actual (rather than the target) air temperature which will be achieved within the building according to that DR action.

Accordingly, the embodiment of FIG. 9 is operable to generate performance data indicative of the outcome, from a user's point of view, of a particular DR action. This performance data may be displayed alongside the controls to select the parameters of the DR action. This gives the user a direct indication of the effect of DR actions upon the user's comfort.

This type of performance data is particularly applicable to fluid heating or cooling arrangements such as air heating, air cooling, water heating and refrigeration systems. In the case of any of these, the performance data can represent at least the output fluid temperature which is expected as an outcome of the power and other constraints applied by the DR action. Other measures of performance data may include, for example, volume of liquid heated (or cooled) to a required threshold minimum temperature, so in an example, this may indicate the number of hot showers per day which the user may enjoy at a minimum acceptable sharing temperature. In these arrangements, the performance data may be indicative of a level of user comfort relating to the fluid temperature.

It is not necessary for real historical data to be used; instead, the role of the measured historical data and the historical data store 1310 could instead be undertaken by pre-populated data (for example, supplied by the device manufacturer and possibly adjusted at installation in response to measurements of the user's premises) or by analytical functions, again pre-populated by the manufacturer. In a further alternative, the operations described above could initially be carried out on the basis of pre-populated data or functions, but these may be refined based on actual performance measurements over a period of time.

A further use of the historical data is as follows. If the aggregator presents candidate DR events for selection at the DR installation, the comparator 1300 can compare each of the candidate events with actual historical data indicating previous real actions of the user. The comparator 1300 can then select one or more of the candidate DR events to be presented to the user which are closest to the user's real historical activity and/or which would provide the greatest potential user rewards. So, for example, if the user typically likes to keep the user's premises at a minimum air temperature of 18° C. during the winter, a DR event offered by the aggregator which would allow the minimum air temperature to drop to (say) 12° may be unacceptable to the user and so the comparator would not normally select that DR event for presentation to the user. However, if the user reward associated with that candidate event was sufficiently high (exceeding a predetermined threshold amount) then the comparator 1300 may select that candidate event for presentation as an option to the user.

Accordingly, the user control and display unit is operable to store data indicative of historical resource usage by the controlled device(s), to detect, from information received from the aggregator, user rewards associated with variations in time and consumption parameters with respect to the historical usage, and to select, for presentation to the user, DR events which represent either or both of: the greatest user rewards, and the smallest changes with respect to historical usage.

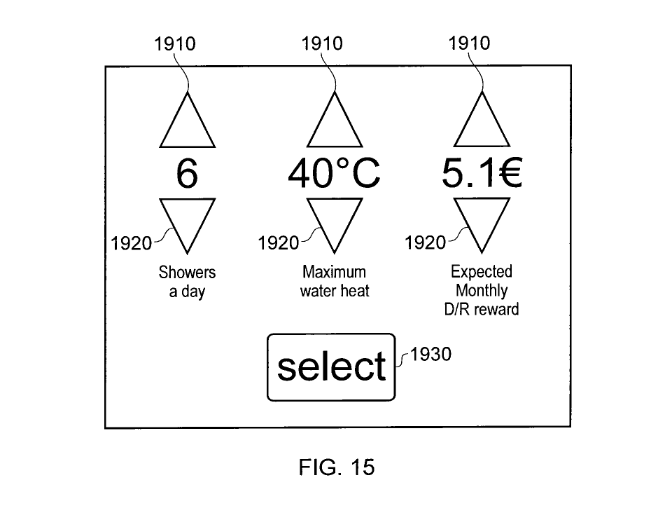

The actual use of performance data may be in one of two forms. The user may set up a DR action (for example, setting power availability periods and thermostat settings) and then, before selecting that DR action, see the anticipated effect on the user's comfort in terms of the anticipated performance data. In another format, the user may define the user's requirements in terms of performance data (for example, the user requires six showers per day) and then see the effect in terms of the expected user reward available for the DR action calculated by the control generator 1225 to provide that level of performance. In fact, in some embodiments (such as that discussed below with reference to FIG. 15) these two approaches can be combined, so that user controls can be provided to allow the user to vary the performance and/or the expected user DR reward, noting that a change to one of these parameters will ripple through to corresponding changes to the others. So, if the user attempts to increase an expectation of DR reward, it may be that other performance parameters such as the number of showers that the user can take per day will suffer.

Before various examples of screen displays are discussed, FIGS. 10-12 schematically illustrate different embodiments of user displays and user controls.

FIG. 10 schematically illustrates a simple arrangement having a separate user display 1410 and user controls 1420. In contrast, FIG. 11 schematically illustrates a combined approach in which a touchscreen display 1510 was associated with a touchscreen detector 1520, so that user touch on the display at positions corresponding to so-called “soft” keys can be detected as user inputs. FIG. 12 schematically illustrates the arrangement of FIG. 14 in slightly more detail, in that a display 1610 is provided along with a keyboard decoder 1620 which is connected to multiple user-operable buttons or switches 1630. The keyboard decoder detects which of the switches or buttons 1630 has been operated and sends information corresponding to that operation to the input controller 1240.

FIGS. 13-15 schematically illustrate examples of user displays. These provide examples of user controls for setting parameters determining the resource consumption (in these examples, electricity consumption) of a future resource-consuming event or events (for example, a dishwashing or water heating event) by a specific resource-consuming device (for example, a dishwasher or water heater), the future resource-consuming event being associated with a user reward. Note that this aspect could apply also (or instead) to production, for example in the context of an electric vehicle. The user could specify that the battery of the electric vehicle may be used for DR purposes (as a temporary energy store under the ultimate control of the DR aggregator), but that the battery has to be loaded (charged) to a certain degree by (say) 6 am. The impact on the user's comfort of allowing DR use of the battery would be a possible reduction in driving range and/or a reduction in battery lifetime (as the batteries last for only a certain number of charging cycles). Another example is a combined heat and power device which generates electricity as a by-product of heat generation. Reducing or increasing the electricity production as a DR action has an effect on performance relating to user comfort by reducing or increasing the heat production.

Note that in FIGS. 13-15, the arrangements can update the displayed performance data and user reward automatically in response to a change in the parameters, for example by deriving the performance data and/or the user reward from respective stored data (which may be historical data linking parameters with performance and/or data supplied by the DR aggregator linking user rewards with parameters and/or linking parameters with performance).

FIG. 13 relates to a user display for setting a DR action relating to a dishwashing machine. In this example, a rectangle 1710 schematically illustrates (by its horizontal dimensional) the time taken by the dishwashing machine to clean a load of dishes (in this example, 1:40). A shaded area 1720 indicates the period occupied by this dishwashing cycle if it were to start straightaway. As discussed above, an instantaneous resource-consuming event would not be expected to generate significant (or even any) DR user rewards. The rewards are applied in return for the user allowing flexibility in when the dishwashing cycle should start. By using a touchscreen interface, the user may select (by pressing lightly) the rectangle 1710 and slide it from left to right in order to select a latest permissible time for the dishwashing cycle to finish. In the example shown, the user has moved the rectangle 1710 towards the right side to indicate a latest acceptable end time of 17:35, which in turn means a latest acceptable start time of 15:55. Within that range (from the current time to 15:55) the DR system may choose when to start the dishwashing cycle. Similarly, by using a “choose and slide” interface in which a shaded rectangle 1730 may be extended or retracted, the user can choose a dishwashing water temperature between the limits of 45° and 65°. The illustration shows an example selection of a temperature (under the control of the DR system) up to 55°. A box 1740 on the display indicates the number of “points” (as an example expression of a user reward) calculated in respect of this DR action by the control generator 1220 or 1225 using the parameter data stored in the data store 1210. The user may press a “select” button 1750 when the user is happy with the set of parameters displayed on the user display of FIG. 13.

So, this arrangement provides a user control for setting one or more parameters determining the resource consumption and/or production of a future event or future events (for example, a dishwashing cycle) by a specific resource consuming and/or producing device, the one or more parameters including a time period, longer than the length of the event itself, during which the user allows the events take place. The event is associated with a user reward specific to that event.

The display in FIG. 13 also provides an example of a display for displaying, to the user, (i) performance data indicating the predicted effect of setting the parameters on the performance of the resource consuming and/or producing device relative to one or more predetermined user requirements, so that the displayed performance data varies with variations in the one or more parameters set by the user control (or in other words, the time at which the dishwasher cycle will terminate, and the dishes will be clean, changes), and (ii) the user reward associated with at least currently selected parameters (the reward in the box 1740 changes accordingly).

FIG. 14 illustrates a different representation of the same data as that shown in FIG. 13, in which the water temperature is selected by touching the screen button 1810 and the runtime (and latest permissible end time) of the dishwashing cycle is set by a rotary control 1820 in which a slider 1830 may be slid clockwise in order to move the latest permissible end time to a later time. In this example the screen button 1810 may indicate a maximum temperature, a minimum temperature or a specified (required) temperature. In the particular example of FIG. 14, it indicates a specific required temperature. Note that in embodiments, the different selectable temperatures (coupled with the user variation in the allowable time for the cycle to take place) may be considered as examples of one or more candidate future resource consuming and/or producing events for user selection; as the reward in the box 1740 changes with each such selection, this provides an example of each such candidate event being displayed with an associated user reward and associated performance data. The temperature variations provide an example of a set of candidate events in which at least some of the candidate resource consuming and/or producing events differ from one another by an averaged or peak operational parameter of the resource consuming device over a period of time.

FIG. 15 schematically illustrates a further example of the display of performance data. As discussed above, the user is provided with controls to vary energy input parameters (such as the maximum water temperature), performance parameters (such as a number of showers required per day at a particular shower volume set as a predetermined parameter or in the historical data store) and anticipated DR user reward. Note that each of these parameters may be adjusted individually by means of up 1910 and down 1920 controls which the user may press on a touchscreen interface. Whenever one of the parameters is adjusted, the effect on the others is automatically generated by the control generator 1225. When the user is happy with the combination of data is displayed, the user may press a “select” button 1930 choose that combination as a DR action. Note that the water temperature as displayed is the water temperature as experienced by the user, not the temperature inside of the water heater buffer. The temperature variations in the maximum water heat provide an example of a set of candidate events in which at least some of the candidate resource consuming and/or producing events differ from one another by an averaged or peak operational parameter of the resource consuming device over a period of time. Also, in this example, the resource consuming and/or producing device is a fluid heating or cooling device; the operational parameter is an output temperature of the fluid; and the performance data is indicative of a level of user comfort relating to the fluid temperature.

Accordingly, in this arrangement, the display provides performance data to the user indicating the predicted effect of setting various parameters on the performance of the device relative to one or more predetermined user requirements (for example, number of showers in a day) so that the displayed performance data varies with variation in the one or more parameters set by the user.

The arrangements of FIG. 15 provide an example of a system in which the resource consuming and/or producing device is a water heating device; the water heating device comprises a hot water buffer for storing heated water, and from which the user draws hot water for use; and the performance data is indicative of a predicted future amount of stored hot water that will be available for use above a predetermined minimum water temperature. But more generally, the principles illustrated in these example embodiments may equally be applied to arrangements in which the resource-consuming and/or producing device is selected from the list consisting of: an air cooling device; an air heating device; a water heating device; a combined heat and power generator; and an electric vehicle.

As noted above, the user display and control apparatus may be connectable to the resource consuming and/or producing device so as to control resource consumption and/or production by the resource consuming and/or producing device, for example by means of a power controller 360, 370.

Note that although the controls described above could be implemented in respect of individual DR actions, in embodiments the user may make this type of selection relatively infrequently, so as to offer more DR flexibility on a longer term basis. The DR reward is then provided for the flexibility (for example, the user indicating that the user does not mind having one fewer shower in a week, on a medium to long term basis), rather than for an individual occasion of (say) missing a particular shower.

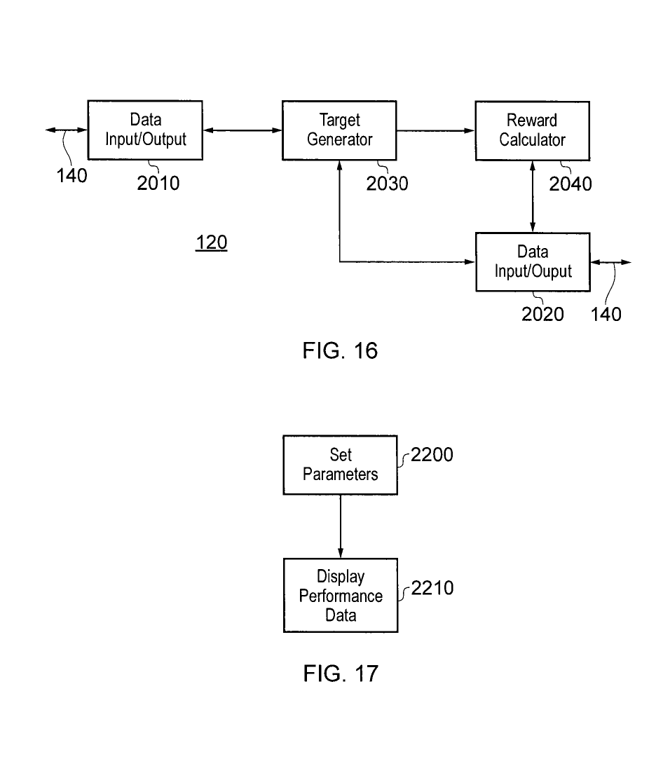

FIG. 16 schematically illustrates an example of the aggregator 120. The aggregator 120 may be implemented as a server arrangement comprising a first and second data input/output units 2010, 2020 connectable to and for communicating with the BRP 110 and DR installations 130 respectively, a target generator 2030 and a reward calculator 2040. In operation, the target generator 2030 receives information from the BRP via the link 140 defining future or current load balancing requirements of the BRP. From this, the target generator 2030 derives target changes to the expected load provided by the devices at the various DR installations 130. The reward calculator 2040 generates a reward package associated with implementing respective candidate DR actions or events to incentivise the users at the DR installations to adopt load balancing measures which will assist the BRP, this forming an example of the server generating information defining one or more user rewards associated with implementing respective candidate future resource-consuming and/or producing events. The data input/output unit 2020 transmits details of the load balancing measures (DR actions) and the associated rewards to the DR installations. Note that the data input/output unit 2020 also receives information back from the DR installations indicating DR actions adopted by those installations (and, in due course, verified by the prosumption detector). This information can be passed to the target generator and/or the reward generator so that the remaining portion of the target variation in load defined by the target generator 2030 is established and further rewards potentially offered in order to incentivise the adoption of the further required DR actions. In this way, the aggregator and the DR installation are operable to communicate in respect of a resource consuming event verified by the prosumption detector so as to provide the user reward to a user associated with that DR installation.

The server may be connectable to a group of control apparatuses comprising multiple control apparatuses, the server being operable to aggregate the resource consumption and/or production relating to events selected by the multiple control apparatuses in the group, so as to control a resource supply to the devices associated with the group of apparatuses. Each control apparatus is operable to receive from the server one or more parameters defining potential future resource consuming and/or producing events and associated user rewards.

FIG. 17 provides a schematic flowchart illustrating the following steps relating to a control method, which may (for example) be implemented by the user control and display unit 340 described above. The steps comprise:

a step 2200 of setting one or more parameters determining the resource consumption of a future resource-consuming event by a specific resource consuming device, the one or more parameters including a time period, longer than the length of the resource-consuming event itself, during which the user allows the resource-consuming event to take place, the future resource-consuming event being associated with a user reward; and

a step 2210 of displaying, to the user, performance data indicating the predicted effect of setting the parameters on the performance of the resource consuming device relative to one or more predetermined user requirements, so that the displayed performance data varies with variations in the one or more parameters set by the user control.

These method steps may be, for example, carried out by programmable or semi-programmable hardware such as a general purpose computer, a field-programmable gate array (FPGA) or an application specific integrated circuit (ASIC) operating under the control of appropriate computer software or firmware. it will be appreciated that such software, and a storage medium (for example, a non-transitory machine-readable storage medium such as a read-only memory, a non-volatile random access memory, a magnetic disk or an optical disk) which stores such software are considered to represent embodiments. Note that at least some functionality as described above may be implemented by servers associated with the DR aggregator and/or on cloud-based devices or processes. Combinations of different implementations are considered to fall within the scope of the appended claims.

Measured effects need not be represented as an absolute series of measurement values, e.g. power. They can also be converted to a fingerprint so that they can be compared to database of plausible fingerprints for a particular DR action.

Profiles need not be values over time (such as energy, power, voltage, current). It can also be values at certain frequencies. e.g. a high-frequency voltage spectrogram (good for determining device presence/absence). Or it can be a combination of several types of measurement.

The measurement devices can be close to a device (which in turn makes it possible or at least more straightforward to verify the presence of a device, for example by measuring the device's impedance) or further away, towards the mains meter or supply inlet (in which case it becomes harder to substitute devices for one another).

The profiles can also be used to warn users about malfunctioning devices, such as (for example) an electric boiler that is using much more electricity than it is supposed to. This may at the same time give bona fide users a change to verify the working of their appliance and deter potentially malicious users from engaging in fraudulent activities since they know actual usage is monitored.

In embodiments the measuring arrangement is integrated with the apparatus that sends DR control signals to devices. In either event, strong encryption such as 128 bit AES encryption and/or message authentication with 256-bit SHA-1 can be used between the measuring arrangement and the part of the apparatus that interprets the measurements as to whether it is compliant with the requested DR action. Encryption of this type may be used for other (or all) data communication discussed above.

There are various examples of potential consequences of successful and failed verifications. In the case of successful verification, a reward is in order, but in case of failure one might not a give a reward, or instead a penalty, or instead (or as well) a (number of) warning(s). The result of the verification step also does not need to lead to a direct decision on assigning or withholding of a DR reward. It can be simply one of many contributing factors.

The outcome of a DR verification need not be a binary decision. It can also be a probability of compliance. The DR aggregator can then act when the combined probability of compliance of a number of separate DR actions falls below a threshold.

Turning now to potential additional and/or optional features of the embodiments relating to control of DR devices, these are listed below:

In respect of an example system using a water heater and buffer, a user can select the maximum guaranteed number of showers at a selectable temperature (of a fixed duration). As a result, the expected reward will be immediately updated.

Some variations include:

a) Different graphical layouts
b) Even more directly comfort- or performance-related settings for the temperature
c) More setting parameters visible: for example, shower duration, volume of water in bath tub, adjustable size of a buffer or reserve amount of hot water for use by white goods such as washing machines, CO₂ reduction achieved, average reward for neighbourhood, average reward for friends in a social network group
d) Different setting parameters selectable: for example, showers in different time slots (so that (for example) 6 showers per day≠3 showers per half day), cost, rewards and performance in respect of baths instead of showers, CO₂ reduction used as a user reward instead of money
e) Detailed explanations and/or graphics about the settings, for example in the form of built-in help data.
f) Relative setting parameters: for example, instead of absolute numbers as in the drawings, use +/−n, where n is an increment or decrement rather than an absolute parameter. For example, the controls can provide for the selection of one more shower per day than is currently set or the setting of the water to be 2 degrees warmer.
g) Rewards points can be used instead of monetary reward so that larger numbers can be achieved. Also, it makes more sense to tune the outcome and let the parameters change. For example, for 250 points extra, the user has to trade in 1 shower per day. Note that reward points need not be linear with regard to the actions taken.

Thus, the foregoing discussion discloses and describes merely exemplary embodiments. As will be understood by those skilled in the art, the present technology may be embodied in other specific forms without departing from the spirit or essential characteristics thereof. Accordingly, the disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

Embodiments of the present disclosure can provide features set out in the following numbered paragraphs:

1. A control apparatus comprising:

a user control for setting one or more parameters determining the resource consumption and/or production of future resource-consuming and/or producing events by a specific resource consuming and/or production device, the one or more parameters including a time period, longer than the length of each resource-consuming and/or producing event itself, during which the user allows that resource-consuming and/or producing event to take place, the future resource-consuming and/or producing events being associated with a user reward; and

a display for displaying, to the user, (i) performance data indicating the predicted effect of setting the parameters on the performance of the resource consuming and/or producing device relative to one or more predetermined user requirements, so that the displayed performance data varies with variations in the one or more parameters set by the user control, and (ii) the user reward associated with at least currently selected parameters.

2. Apparatus according to paragraph 1, comprising a display for displaying one or more candidate future resource consuming and/or producing events for user selection, each candidate event being displayed with an associated user reward and associated performance data.
3. Apparatus according to paragraph 2, in which at least some of the candidate resource consuming and/or producing events differ from one another by an averaged or peak operational parameter of the resource consuming device over a period of time.
4. Apparatus according to any one of paragraphs 1 to 3, in which:

the resource consuming and/or producing device is a fluid heating or cooling device;

the operational parameter is an output temperature of the fluid; and

the performance data is indicative of a level of user comfort relating to the fluid temperature.

5. Apparatus according to any one of paragraphs 1 to 4, in which the resource-consuming and/or producing device is selected from the list consisting of: an air cooling device; an air heating device; a water heating device; a combined heat and power generator; and an electric vehicle.
6. Apparatus according to any one of paragraphs 1 to 5, in which:

the resource consuming and/or producing device is a water heating device;

the water heating device comprises a hot water buffer for storing heated water, and from which the user draws hot water for use; and

the performance data is indicative of a predicted future amount of stored hot water that will be available for use above a predetermined minimum water temperature.

7. Apparatus according to any one of the preceding paragraphs, the apparatus being connectable to the resource consuming and/or producing device so as to control resource consumption and/or production by the resource consuming and/or producing device.
8. Apparatus according to any one of the preceding paragraphs, in which the resource consuming and/or producing device is an electrical device.
9. Apparatus according to any one of the preceding paragraphs, the apparatus being operable to update the displayed performance data and user reward in response to a change in the parameters.
10. Apparatus according to any one of the preceding paragraphs, the apparatus being operable to derive the performance data from stored data associating parameters with performance.
11. Apparatus according to any one of the preceding paragraphs, the apparatus being operable to derive the user reward for display from data associating user rewards with parameters.
12. A control system comprising:

control apparatus according to any one of the preceding paragraphs; and

a server connectable to the control apparatus, the server generating information defining one or more user rewards associated with implementing respective candidate future resource-consuming and/or producing events.

13. A system according to paragraph 12, in which the server is connectable to a group of control apparatuses comprising multiple control apparatuses, the server being operable to aggregate the resource consumption and/or production relating to resource consuming events selected by the multiple control apparatuses in the group, so as to control a resource supply to the resource consuming and/or producing devices associated with the group of apparatuses.
14. A system according to paragraph 12 or paragraph 13, in which the control apparatus is operable to receive from the server data defining potential future resource consuming and/or producing events and associated user rewards.
15. A system according to any one of paragraphs 12 to 14, in which the control apparatus is operable:

to store data indicative of historical resource usage and performance relating to the resource consuming and/or producing device;

to detect, from the information generated by the server, the user rewards associated with variations in time and consumption and/or production parameters with respect to the historical usage; and

to select, as candidate future resource consuming and/or producing events for display to the user, one or more future resource consuming and/or producing events which represent either or both of: the greatest user rewards, and the smallest changes in device performance with respect to the historical performance.

16. A control method comprising:

setting one or more parameters determining the resource consumption and/or production of a future resource-consuming and/or producing event by a specific resource consuming and/or producing device, the one or more parameters including a time period, longer than the length of the resource-consuming and/or producing event itself, during which the user allows the resource-consuming and/or producing event to take place, the future resource-consuming and/or producing event being associated with a user reward; and

displaying, to the user, (i) performance data indicating the predicted effect of setting the parameters on the performance of the resource consuming and/or producing device relative to one or more predetermined user requirements, so that the displayed performance data varies with variations in the one or more parameters set by the user control and (ii) the user reward associated with at least currently selected parameters.

17. Computer software which, when executed by a computer, causes the computer to implement the method of paragraph 16.
18. A non-transitory machine-readable storage medium on which is stored computer software according to paragraph 17.

### CROSS-REFERENCE TO RELATED APPLICATIONS

The present application claims priority of EP patent application No. 13 155 298.6 filed on Feb. 14, 2013, the entire contents of which are incorporated herein by reference.

1. A control apparatus comprising:
a user control for setting one or more parameters determining the resource consumption and/or production of future resource-consuming and/or producing events by a specific resource consuming and/or production device, the one or more parameters including a time period, longer than the length of each resource-consuming and/or producing event itself, during which the user allows that resource-consuming and/or producing event to take place, the future resource-consuming and/or producing events being associated with a user reward; and
a display for displaying, to the user, (i) performance data indicating the predicted effect of setting the parameters on the performance of the resource consuming and/or producing device relative to one or more predetermined user requirements, so that the displayed performance data varies with variations in the one or more parameters set by the user control, and (ii) the user reward associated with at least currently selected parameters.

2. Apparatus according to claim 1, comprising a display for displaying one or more candidate future resource consuming and/or producing events for user selection, each candidate event being displayed with an associated user reward and associated performance data.

3. Apparatus according to claim 2, in which at least some of the candidate resource consuming and/or producing events differ from one another by an averaged or peak operational parameter of the resource consuming device over a period of time.

4. Apparatus according to claim 3, in which:
the resource consuming and/or producing device is a fluid heating or cooling device;
the operational parameter is an output temperature of the fluid; and
the performance data is indicative of a level of user comfort relating to the fluid temperature.

5. Apparatus according to claim 4, in which the resource-consuming and/or producing device is selected from the list consisting of: an air cooling device; an air heating device; a water heating device; a combined heat and power generator; and an electric vehicle.

6. Apparatus according to claim 5, in which:
the resource consuming and/or producing device is a water heating device;
the water heating device comprises a hot water buffer for storing heated water, and from which the user draws hot water for use; and
the performance data is indicative of a predicted future amount of stored hot water that will be available for use above a predetermined minimum water temperature.

7. Apparatus according to claim 1, the apparatus being connectable to the resource consuming and/or producing device so as to control resource consumption and/or production by the resource consuming and/or producing device.

8. Apparatus according to claim 1, in which the resource consuming and/or producing device is an electrical device.

9. Apparatus according to claim 1, the apparatus being operable to update the displayed performance data and user reward in response to a change in the parameters.

10. Apparatus according to claim 1, the apparatus being operable to derive the performance data from stored data associating parameters with performance.

11. Apparatus according to claim 1, the apparatus being operable to derive the user reward for display from data associating user rewards with parameters.

12. A control system comprising:
control apparatus according to claim 1; and
a server connectable to the control apparatus, the server generating information defining one or more user rewards associated with implementing respective candidate future resource-consuming and/or producing events.

13. A system according to claim 12, in which the server is connectable to a group of control apparatuses comprising multiple control apparatuses, the server being operable to aggregate the resource consumption and/or production relating to resource consuming events selected by the multiple control apparatuses in the group, so as to control a resource supply to the resource consuming and/or producing devices associated with the group of apparatuses.

14. A system according to claim 12, in which the control apparatus is operable to receive from the server data defining potential future resource consuming and/or producing events and associated user rewards.

15. A system according to claim 12, in which the control apparatus is operable:
to store data indicative of historical resource usage and performance relating to the resource consuming and/or producing device;
to detect, from the information generated by the server, the user rewards associated with variations in time and consumption and/or production parameters with respect to the historical usage; and
to select, as candidate future resource consuming and/or producing events for display to the user, one or more future resource consuming and/or producing events which represent either or both of: the greatest user rewards, and the smallest changes in device performance with respect to the historical performance.

16. A control method comprising:
setting one or more parameters determining the resource consumption and/or production of a future resource-consuming and/or producing event by a specific resource consuming and/or producing device, the one or more parameters including a time period, longer than the length of the resource-consuming and/or producing event itself, during which the user allows the resource-consuming and/or producing event to take place, the future resource-consuming and/or producing event being associated with a user reward; and
displaying, to the user, (i) performance data indicating the predicted effect of setting the parameters on the performance of the resource consuming and/or producing device relative to one or more predetermined user requirements, so that the displayed performance data varies with variations in the one or more parameters set by the user control and (ii) the user reward associated with at least currently selected parameters.

17. Computer software which, when executed by a computer, causes the computer to implement the method of claim 16.

18. A non-transitory machine-readable storage medium on which is stored computer software according to claim 17.
